(19) United States
(12) Patent Application Publication
(10) Pub. No.: US 2016/0359904 A1
(43) Pub. Date: Dec. 8, 2016

(54) METHOD AND SYSTEM FOR DETECTION OF HEADLESS BROWSER BOTS

(71) Applicant: RADWARE, LTD., TEL AVIV (IL)

(72) Inventors: Yotam BEN EZRA, Raanana (IL); Oren OFER, Rehovot (IL); Deena YEHUDA, Tel-Aviv (IL)

(73) Assignee: RADWARE, LTD., TEL AVIV (IL)

(21) Appl. No.: 15/169,942

(22) Filed: Jun. 1, 2016

Related U.S. Application Data
(60) Provisional application No. 62/170,863, filed on Jun. 4, 2015.

(51) Int. Cl. H04L 29/06

(52) U.S. Cl. CPC H04L 63/1483; H04L 63/08; H04L 63/10; H04L 63/1458; H04L 2463/144; H04L 2463/141; G06F 2221/2103; G06F 2221/2133

(57) ABSTRACT

A method and system for detecting an access to a protected resource by headless browser bots are provided. The method includes receiving a request from a client machine; generating an anti-headless browser bot (AHBB) challenge, wherein the AHBB challenge comprises at least a headless browser identifying characteristic; receiving a response to the AHBB challenge; comparing the response to the AHBB challenge to at least a challenge requirement to determine any one of: a pass result, and a fail result; and upon determining a pass result, granting the client machine access to the protected resource.

### CROSS-REFERENCE TO RELATED APPLICATIONS

This application claims the benefit of U.S. Provisional Application No. 62/170,863 filed on Jun. 4, 2015, the contents of which are hereby incorporated by reference.

### TECHNICAL FIELD

This disclosure generally relates to implementation of security techniques for detecting malicious bots, and particularly to the implementation of headless browser bots to mitigate DoS and/or DDoS attacks.

### BACKGROUND

A significant problem facing the Internet community is that online businesses and organizations are vulnerable to malicious attacks. Recently, attacks have been committed using a wide arsenal of attack techniques and tools targeting both the information maintained by the online businesses and their IT infrastructures. For example, recently identified attacks have been committed using a combination of attack techniques at the network and application levels. Attackers use different tools to execute different attack techniques. Each such attack tool is designed to exploit weaknesses identified in one of the target's defense layers.

An example for such an attack tool is a Web robot, also known as a botnet or bot (which will be referred to hereinafter as a “bot”). A bot is a software application programmed to execute automated tasks over the Internet. Typically, bots are programmed to perform tasks that are simple and structurally repetitive at a higher rate than that of a human end user. Commonly, malicious users often use a bot as a means to execute denial-of-service (DoS) attacks, HTTP or HTTPS flood attacks, click frauds, data theft by means of scraping techniques, and to spam large amounts of content over the Internet.

One type of recently developed bot is a headless browser. Typically, a headless browser is a web browser without a graphical user interface (GUI). Instead of a GUI, a headless web browser merely contains software code that accesses webpages but does not show them to any human being. Headless browsers are legitimately used to provide the content of webpages to other programs for, e.g., web page testing.

Attackers, on the other hand, use headless browsers as malicious bots to attack network and/or computing resources. One type of attack that can be executed by a headless browser is a denial of service (DoS) or a distributed denial-of-service (DDoS), in which an attempt is made to make the resource unavailable to its intended users. Attackers use such headless browser bots to allow them to generate a large scale attack that cannot be easily detected or mitigated.

Specifically, bots in general, and headless browser bots in particular, provide redundancy as the bot machines are located in various different locations, usually in compromised computers. In addition, such bots allow attackers to remain anonymous because the malicious traffic is not generated directly from an attacker's computer.

Bots in general cannot be detected by applying layer-4 (TCP/IP) detection techniques, i.e., techniques that detect malicious traffic at layer-4. Furthermore, applying layer-4 mitigation techniques may prevent legitimate users from accessing a protected website. Therefore, the detection techniques of malicious traffic generated by DoS bots are also conducted at layer-7 (HTTP).

Layer-7 anti-bot techniques typically attempt to verify that a transaction is initiated by a legitimate client application (e.g., web browser) and is under control of the user. Examples for such techniques are a SYN cookie, a web redirect (e.g., 302 HTTP redirect message), a JavaScript challenge, CAPTCHA, and the like.

In a CAPTCHA action, an image is sent to the user device. The image includes alphanumeric characters that are difficult to recognize for an OCR program, but are visible to a human. The user is verified if the characters entered by the user correspond to the characters in the image. Other challenges may request the user's input in a form of, for example, mouse movement, keystroke, and the like.

The JavaScript challenge requires the client (web browser) to include a JavaScript engine (or enable execution of a JavaScript) in order to view the webpage or to perform any action in a webpage. Other JavaScript redirect challenges invite the browser on the client device to respond to such a message by a request for a new URL specified in the redirected message, or to wait for an input from the user. The SYN cookie techniques validate the IP address of the client issuing the transaction. However, such a technique can be easily bypassed by an attack tool (or an application) that owns a real IP address (not a spoofed address). Current attack tools for executing bots are designed to implement redirection mechanisms by default. For example, the JavaScript redirect challenge can be bypassed using a parser and without any JavaScript engine operable in the attack tool. A simple parser is sufficient to bypass the challenge because the JavaScript are static with constant information that should be revealed.

The CAPTCHA action has been determined to be more effective than many other actions, in confirming that a transaction is issued by a human and not malware. However, at the same time, this technique negatively affects the user experience while accessing the web services. The redirect challenges, on the other hand, are seamless for a legitimate user.

Commonly, current layer-7 anti-bot challenges attempt to segregate between traffic generated by bot machines and otherwise used for malicious purposes from legitimate traffic generated by human users. However, the current challenges are insufficient to detect attacks, and in particular DDoS attacks, executed using headless browsers. As noted above, headless browsers are programmed to simulate web browser operations. A headless browser can interpret webpages, and as such can parse JavaScript, click on links, and even cope with downloads.

Therefore, utilization of headless browsers as malicious bots allows attackers to bypass current layer-7 anti-bot HTTP challenge defenses, such as 302 redirect, JavaScript, and mouse movement challenges. As a result, new challenges are required to distinguish headless browsers from legitimate browsers that will enable website to defend against headless browsers.

Therefore, it would be advantageous to provide an efficient solution for detecting malicious headless browser bots and verifying legitimate clients.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for detecting an access to a protected resource by headless browser bots. The method comprises receiving a request from a client machine; generating an anti-headless browser bot (AHBB) challenge, wherein the AHBB challenge includes at least one headless browser identifying characteristic; receiving a response to the AHBB challenge; comparing the received response to at least one challenge requirement to determine a pass result or a fail result; and upon determining a pass result, granting the client machine access to the protected resource.

Certain embodiments disclosed herein also include a system for detecting an access to a protected resource by headless browser bots. The system comprises a processing system; a memory connected to the processing system and configured to contain a plurality of instructions that when executed by the processing system configure the system to: receive a request from a client machine; generate an anti-headless browser bot (AHBB) challenge, wherein the AHBB challenge includes at least one headless browser identifying characteristic; receive a response to the AHBB challenge; compare the response to at least one challenge requirement to determine a pass result or a fail result; and grant the client machine access to the protected resource, upon determining a pass result.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 illustrates a network system utilized to describe the various embodiments.

FIG. 2 illustrates an off-path deployment of a security system configured to carry the disclosed embodiments.

FIG. 3 illustrates a deployment of challenge machines configured to challenge client machines using the disclosed anti-headless browser bot challenges.

FIG. 4 is a flowchart describing a method for detecting headless browser bots according to one embodiment.

FIG. 5 is a flowchart describing a method for generating anti-headless browser bot challenges according to one embodiment.

FIG. 6 is a block diagram of a security system configured to carry the disclosed embodiments.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

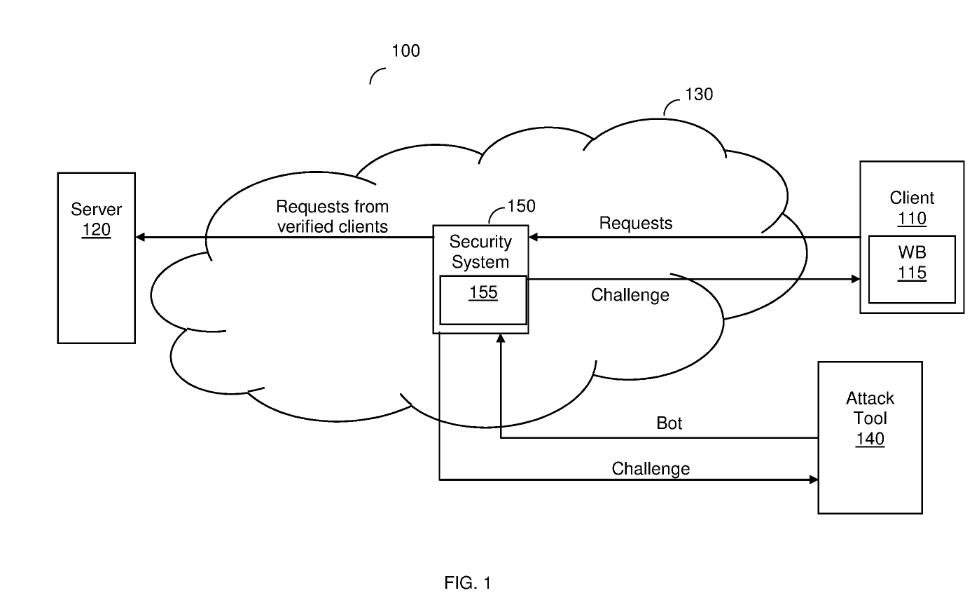

FIG. 1 illustrates an exemplary and non-limiting diagram of a network system 100 utilized to describe the various disclosed embodiments. In the system 100, a client 110 communicates with a server 120 over a network 130. The server 120 is the entity to be protected from malicious threats. The client 110 and server 120 communicate using communication protocols, such as a hypertext transfer protocol (HTTP), HTTPS, and the like. The client 110 is a legitimate and un-authenticated computing device that executes a web browser 115 with a scripting (e.g., JavaScript) engine enabled. The web browser 115 may be realized as a mobile application (“app”), an agent installed in the client 115, an add-on component, a plug-in component, and the like. The client 110 may be a PC, a mobile phone, a smart phone, a tablet computer, and the like.

In the exemplary network system 100, an attack tool 140 is also communicatively connected to the network 130. The attack tool 140 may execute a code (such as a bot or “zombie”) to carry out malicious attacks against the server 120. Such attacks may be, but are not limited to, DoS/DDoS, HTTP/HTTPS flood, click fraud, spam, web scraping and the like. The attack tool 140 can execute an attack by using means other than a bot. The network 130 may be, but is not limited to, a local area network, a wide area network, the Internet, one or more data centers, a cloud computing infrastructure, a cellular network, a metropolitan area network (MAN), or any combination thereof. The cloud computing infrastructure may be a private cloud, a public cloud, a hybrid cloud, or any combination thereof. The attack tool 140 may be a PC, a mobile phone, a smart phone, a tablet computer, a server, and the like. The attack tool 140 executes a headless browser bot that generates malicious traffic. The generated traffic carries at least DoS/DDoS attacks.

It should be noted that, although one client 110, one server 120, and one attack tool 140 are depicted in FIG. 1 merely for the sake of simplicity, the embodiments disclosed herein can be applied to a plurality of clients, attack tools, and servers. Thus, the embodiments disclosed herein can be utilized to detect a large scale attack campaign where a vast number of attack tools participate in attacking the protected entity, i.e., the protected server 120. The clients may be located in different geographical locations. The servers may be part of one or more datacenters, a cloud-computing infrastructure, server frames, or combinations thereof. The server 120 may be, but is not limited to, a web server, an application server, and the like.

In accordance with one embodiment, illustrated in FIG. 1, a security system 150 is connected in-line with the server 120 (i.e., an in-line deployment). The security system 150 is configured to receive requests (HTTP/HTTPS requests) generated by the client 110 and/or attack tool 140. The requests are directed to the protected server 120.

In an embodiment, the security system 150 includes a verification circuit 155 configured to generate an anti-headless browser bot (AHBB) challenge that cannot be passed by an attack tool 140 executing a headless browser. The generated AHBB challenge can be resolved by the client 110 without impacting the performance of serving the client's request and/or requiring additional computing resources from the client 110. That is, any client running a web browser can seamlessly bypass the AHBB challenge.

In an embodiment, the AHBB challenge generated by the verification circuit 155 is configured or otherwise programmed to detect malicious traffic generated by the headless browsers bots executed by the attack tool 140. The headless browser bot can be implemented using one or more of the following techniques PhantomJS, HtmlUnit, SlimerJS, CasperJS, ZombieJS, NightwatchJS, Chimera, Dalek.js, Ghost, Awesomium, and the like. One of ordinary skill should be familiar with these techniques. In an embodiment, the security system 150 and the verification circuit 155 can detect malicious traffic generated using headless browsers bots implemented using any of these techniques.

As will be described in detail below, the verification circuit 155 is configured to generate different types of AHBB challenges to detect the malicious traffic. The AHBB challenges are designed to preform layer-7 analysis to detect if the bot behaves as a standard web browser and/or as a headless browser.

In one embodiment, the detection of standard web browsers (e.g., Internet Explorer®, Safari®, Chrome®, Firefox and the like) is based on identification of common characteristics of such browsers and creating an AHBB challenge receptive thereof. That is, the generated AHBB challenge attempts to confirm if each of the attack tool 140 and the client 100 complies with the identified characteristics to determine the type of browser that generates the received traffic (HTTP/HTTPS requests). If the AHBB challenge is passed, the source of the received traffic is a legitimate machine. The verification circuit 155 is configured to authenticate the client 110 only if the AHBB challenged is passed.

In an exemplary and non-limiting embodiment, the generated AHBB challenge is a zero-window size challenge. This challenge is generated to detect if the attack tool 140 or the client 110 complies with the common characteristics of a standard web browser. Specifically, standard web browsers, like any other window based program, have a window size bigger than zero. A typical web browser's window displays an address bar, windows minimize/close, print, bookmark buttons, and the like. In contrast, the normal window size for headless browsers is zero because they do not use a graphical user interface (GUI) window. The disclosed zero-window size AHBB challenge includes a script or an object that checks the window size. It the window size is determined to be zero, the browser is likely to be a headless browser.

In one embodiment, the generated AHBB challenge is designed to determine if the attack tool 140 behaves as a headless browser. This is performed by checking if the tool complies with one or common characteristics of headless browsers. The challenge will send a script or object that will attempt to identify one or more common headless browsers' characteristics. If the challenge is passed, the source of the received traffic is a legitimate machine. The verification circuit 155 is configured to authenticate the client 110 only if the challenged is passed. The common characteristics of headless browsers can be detected by offline processing of different types of headless browsers.

In an exemplary and non-limiting embodiment, the generated challenge attempts to test the operation of script engines, e.g., JavaScript engines in the browser. Specifically, the challenge attempts to include one or more special objects that are not typical in standard web browsers. These objects are designed to emulate the operation of a standard web browser. The challenge is deigned to determine whether these special objects are executed by the attack tool 140.

As illustrated in FIG. 1, the security system 150 receives requests from either the client 110 or the attack tool 140 and responds with an AHBB challenge. The AHBB challenge may be encapsulated or realized as script code, such as a JavaScript, or any other script programming languages. The verification circuit 155 is configured to generate, for each received request, a new script that includes an AHBB challenge to be discovered by the client 110 (or the attack tool 140) sending the request. In order to pass the AHBB challenge, the client's 110 browser must be a standard web browser.

In an embodiment, the script code including the AHBB challenge is polymorphic and cannot be interpreted by an attack tool 140 implementing parsing programs or lightweight JavaScript interpreters. Therefore, the attack tool 140 or hackers using such a tool would not be able to reverse the generated challenges or to code an automated process for parsing and extracting the challenge from the script code.

In an embodiment, the generated challenge requires a human interaction challenge as another layer of verification. The human interaction may include a mouse movement, a mouse pointing, a drag-and-drop action, and so on.

The polymorphism of the script code is realized by using a different new secret and different semantic phrase to reveal the secret in each new script sent to the client 110 or attack tool 140. The secret is randomly generated or selected form a pool of secrets that can be used. In an exemplary embodiment, the secret is a string of characters. The secret is broken into atom units that are stored in temporary variables in a random order. An atom unit is a smallest size portion of the secret. For example, an atom unit may be a single character or a bit. To add a further barrier to the script code, fake atom units that are not part of the secret are placed in dummy variables. The temporary and dummy variables are part of the script code. An example for generation of the polymorphic script challenge can be found in a co-pending U.S. application Ser. No. 14/182,869, titled “METHOD AND SYSTEM FOR DETECTION OF MALICIOUS BOTS,” assigned to common assignee, and incorporated herein by reference.

The verification circuit 155 is further configured to receive a response from a machine executing the AHBB challenge. For example, the response may include a window size value or an identification of special objects as noted above. In a non-limiting embodiment, an execution of the AHBB challenge returns a message that may be either “passed” or “failed”. In that embodiment, whether the AHBB challenge was passed depends on the message returned (i.e., a “passed” message means that the AHBB challenge was passed). In another non-limiting embodiment, the AHBB challenge is “passed” if the response to the AHBB challenge meets a challenge requirement. A challenge requirement may be, but is not limited to, a window size requirement (e.g., greater than zero), a user interaction (e.g., a mouse click on a specific pixel or group of pixels, dragging and dropping an item, etc.), and so on.

The verification circuit 155 authenticates the client 110 only if the client “passed” the AHBB challenge. Upon such an authentication, the verification circuit 155 relays the received request to the protected server 120, or causes the client 110 to resend the request to the server 120. If the authentication fails (a failed message is returned), the client 110 or the attack tool 140 is blocked from accessing the server 120. In one embodiment, the attack attempt is reported to a security administrator. Such a report may include information about the type of attack and the attacker (e.g., an IP address, a geographical location, and a type of the attack tool).

According to one embodiment, a determination is made if the machines (e.g., client 110 or attack tool 140) accessing the server 120 should be challenged in order to mitigate a DoS/DDoS attack. This is performed in order to reduce the processing of additional scripts. The determination is based on one or more plurality of risk parameters that can be gathered by the security system or received from external systems. These parameters include, for example, a black list of known malicious clients (identified by P addresses, fingerprints, etc.), a list of trusted clients per IP address, a reputation scores per IP address or geographical region, application layer parameters (e.g., clients' cookies), a client unique identification (ID) token, an affiliation of a client (e.g., a client belongs to a trusted company or is an internal client of the organization), parameters collected from external and internal client authentication services, geo analysis (e.g., the origin of a client's traffic in comparison to other clients), a type of content and/or application accessed by the client, on-going attack indications, and on the like. Other parameters related to the protected server can be used to determine if a challenge is required. Examples for such parameters include current load, available computing and/or networking resources, and the like.

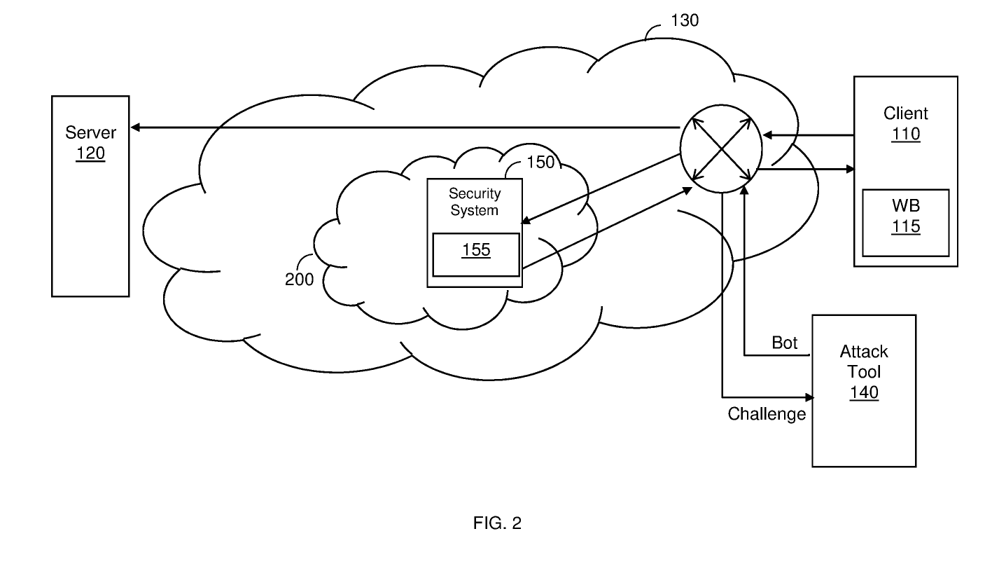

In the exemplary FIG. 1, the verification circuit 155 can be implemented in the server 120. In another embodiment, illustrated in FIG. 2, the security system 150, and hence the verification circuit 155 can be deployed off-path of the server 120 in a secured datacenter 200. In this embodiment, suspicious requests can be diverted to the secured datacenter 200 for authentication. The secured datacenter 200 can be operable in a cloud-system infrastructure, a hosting server datacenter, service provider networks, or a cooperative network.

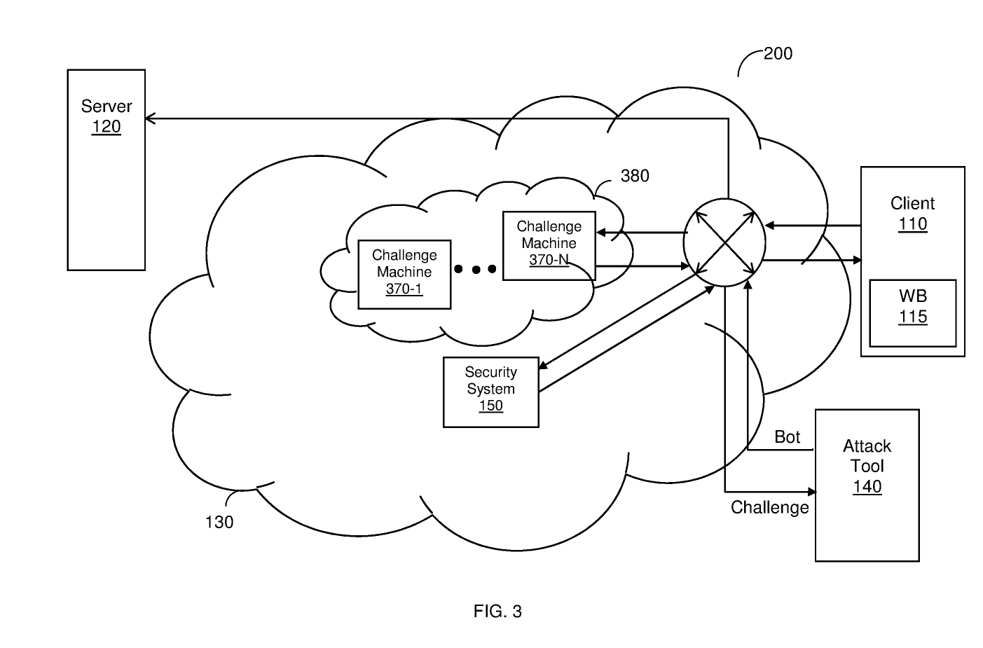

In another embodiment, the AHBB challenges can be generated and validated by one or more challenge machines in a cloud computing infrastructure. FIG. 3 illustrates an exemplary and non-limiting diagram of a network system 300 of system deployment. Connected to the network 130 are the client 110, the protected server 120, and the attack tool 140, the operation of each of which is discussed with reference to FIG. 1.

In the example embodiment illustrated in FIG. 3, the security system 150 is communicatively connected to a cloud computing platform 380. The cloud computing platform 380 may be a public cloud, a private cloud, a hybrid cloud, or any combination thereof. Alternatively or collectively, the cloud computing platform 380 may be realized as a hosting server datacenter, service provider networks, or a cooperative network.

The cloud computing platform 380 includes a plurality of challenge machines 370-1 through 370-N (hereinafter referred to collectively as challenge machines 370 or individually as a challenge machine 370) communicatively connected to the security system 150 and to the network 130.

The challenge machines 370-1 through 370-N authenticate unknown client machines and users trying to access the protected server 370. The security system 150 allows a client to access the protected server 120 upon authentication by a challenge machine 370. In an embodiment, each of the challenge machines 370 is configured to generate and send AHBB challenges to validate the client 110 and/or the attack tool 140. The AHBB challenges provided by the machines 370 are designed to detect headless browsers as discussed herein. The security system 150 and thereby the challenge machines 370 implement the disclosed embodiments to allow segregation between human-operated clients and machine-operated clients. In an embodiment, each machine 370 can generate a different type of an AHBB challenge. For example, the machine 370-1 can generate a zero-window size challenge AHBB challenge while the machine 370-n can generate a special object challenge. It should be noted that the challenge machines 370 can generate other types of challenges including, but not limited to, a SYN cookie, a web redirect (e.g., 302 HTTP redirect message), a JavaScript challenge, a CAPTCHA, and the like.

The challenge machines 370 can be configured by the type of challenge and by the challenge version via, e.g., a system administrator or the security system 150. It should be noted that such configuration or installation of new authentication challenges, or updates thereof can be performed on-the-fly without shutting down the operation of the security system 150. For example, if a challenge machine 370-1 is updated or added with a new challenge version, requests can still be verified using, e.g., challenge machines 370-2, . . . , and/or 370-N. Therefore, the dynamic configuration of the challenge machines 370 does not stall the protection provided to the server 120.

The challenge machines 370 may be physical devices or virtual instances executed within a physical device. Each virtual instance can be addressed by a MAC address, a port number, one or more VLAN IDs, an IP address, packet encapsulation such as generic routing encapsulation (GRE), a network service header (NSH), or any combination thereof. Each virtual instance of a challenge machine can be created on-demand. Thus, according to one embodiment, during war times, there are more active virtual instances of challenge machines than during peace times. An example for generation of the polymorphic script challenge can be found in a co-pending U.S. application Ser. No. 14/520,955, titled “TECHNIQUES FOR OPTIMIZING AUTHENTICATION CHALLENGES FOR DETECTION OF MALICIOUS ATTACKS,” assigned to common assignee, and incorporated herein by reference.

The instantiation and de-instantiation of challenge machines 370 can be triggered and controlled by the security system 150, by an external security monitoring tool, and/or by a system administrator. In an embodiment, the resources required to mitigate an ongoing attack are constantly monitored, and resources, i.e., virtual instances of challenge machines, are allocated to mitigate the attack on demand. Once the attack is over, such resources can be released.

In the deployment shown in FIG. 3, the security system 150 is configured to receive a request from an unauthenticated client such as, e.g., the client 110 or the attack tool 140. In response, the verification circuit 155 in the security system 150 is configured to send a redirect script to the client 110 and/or to the attack tool 140 redirecting the client's browser to one of the challenge machines 370. A redirect script may be realized as an AJAX call. In an embodiment, the redirect script includes a set of parameters required to generate an authentication object by the challenge machine 370 to which the client is directed to. The set of parameters may include, for example, an IP address of the client, a time stamp, a current port number, and the like. The authentication object may be, but is not limited to, a cookie, a token, or any other type of data structure that can carry the information discussed in greater above.

The challenge machine 370 to which the client 110 and/or attack tool 140 is directed challenges the unauthenticated client 110 and/or attack tool using an AHBB authentication challenge. Upon successful authentication, the unauthenticated client 110 is forwarded to the protected server 120 with the valid authentication object generated by the machine 370. The security system 150 is configured to evaluate the authentication object. If the received authentication object is determined to valid by the security system 150, the client's request is forwarded to the protected server 120; otherwise, the request is rejected or other actions preventing the client 110 from accessing the server 120 is taken.

In various embodiments, upon authentication of a client (e.g., client 110), the security system 150 is configured to mark that client 110 as a legit client (e.g., based on the client source IP Address, a client's fingerprint, etc.). Thereafter, all requests from the client 110 are forwarded to the server 120 or a direct connection is established between them. Connections with clients that failed the authentication process (e.g., the attack tool 140) are terminated or otherwise suspended by the security system 150. In an embodiment, clients that failed the authentication challenges are directed back to the system 150. In one embodiment, an aging mechanism (e.g., a timer) is implemented to ensure that each client will be re-authenticated after a predefined time interval regardless of whether the client failed or passed pervious authentication attempts. In another embodiment, clients may be permanently blocked after a pre-configured number of failed authentication attempts.

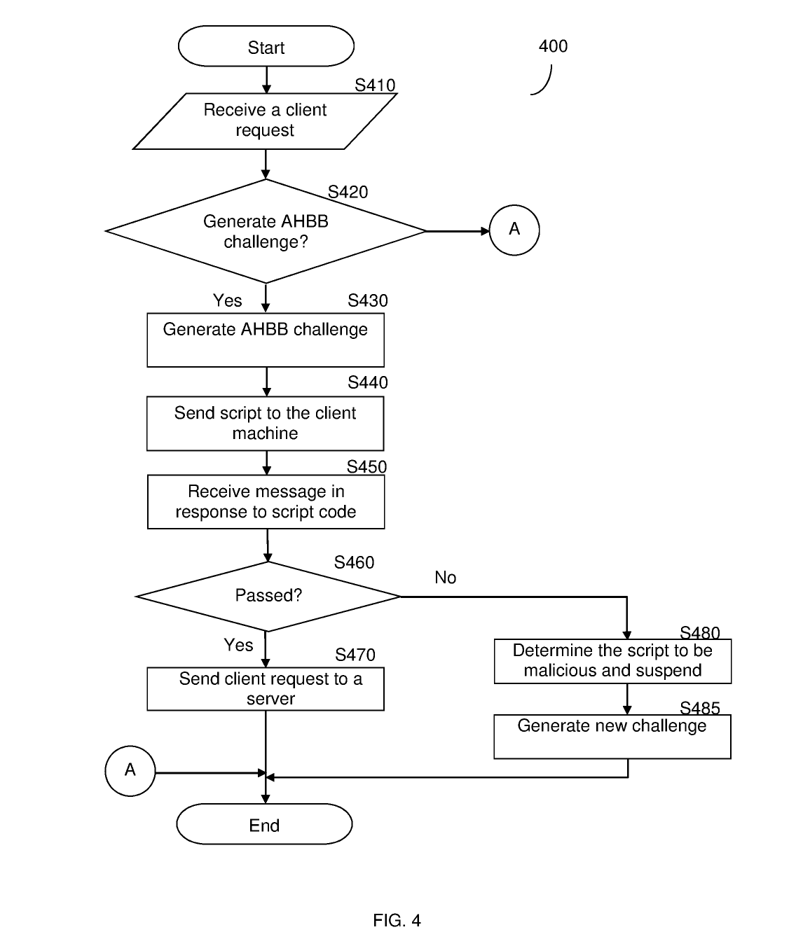

FIG. 4 is an exemplary and non-limiting flowchart 400 describing the operation of the security system 150 for at least detecting headless browser bots according to one embodiment. As noted above, the detection of such headless browser bots may allow the mitigation and detection of at least DoS/DDoS attacks.

At S410, a request to access a resource of a protected server is received from a client machine. The request may be, for example, a HTTP or HTTPS request. The client machine may be a legitimate client or an attack tool executing a bot. Optionally, at S420, a check is made to determine if an AHBB challenge should be generated. The determination is based on a plurality of risk parameters and/or load parameters that can be gathered by the security system or received from external systems. The risk parameters include, for example, a black list of known malicious clients (identified by P addresses, fingerprints, etc.), a list of trusted clients per IP address, a reputation scores per IP address or geographical region, application layer parameters (e.g., clients' cookies), a client unique identification (ID) token, an affiliation of a client (e.g., a client belongs to a trusted company or is an internal client of the organization), parameters collected from external and internal client authentication services, geo analysis (e.g., the origin of a client's traffic in comparison to other clients), a type of content and/or application accessed by the client, ongoing attack indications, and so on. The load parameters relate to the protected server, for example, current load, available computing and/or networking resources, and the like. If S420 results with a “Yes” answer, execution continues with S430; otherwise, execution ends. If S420 is not performed, execution proceeds S430.

At S430, at least one AHBB challenge is generated to detect a headless browser. The AHBB challenge is coded or encapsulated in a script code, such as, but not limited to JavaScript. The execution of S430 is described in detail above. At S440, the generated script is sent to the client machine.

At S450, a message (or a token) is received from the client machine in response to the script code. At S460, the content of the message (or a token) is analyzed to determine if the challenged passed or failed. In a non-limiting implementation, the received message explicitly designates if the message failed or passed. It should be noted that, if no message is received during a predefined time interval, the challenged is considered failed. The waiting time for receiving a message may be preconfigured and can be set to a typical round trip time (RTT) between the protected server and security system.

If the received message indicates a passed challenge, execution continues with S470; otherwise, execution proceeds to S480, where the received request is determined to be malicious and the received request is terminated or suspended. Optionally at S485, a new challenge may be generated and send to the client machine according to a predefined escalation policy. An escalation policy defines a certain order in which to perform a set of different challenges based on an attack's type, properties of the client (attacker), the entity to be protected, and so on. As a non-limiting example, such an escalation scenario may define a first challenge as a zero-window size challenge, a second challenge is a special object type of AHBB challenge, and the third challenge would require an input from the user. In an embodiment, S485 may also include gathering and reporting details about the client machine sending the malicious request. Such details include, but are not limited to, an IP address, a geographical location, type of the machine, request type, and the like.

At S470, the client machine is authenticated and the client request received at S410 is relayed to the server. Alternatively, the client machine is triggered to resend the request to the server (e.g., server 120). It should be noted that subsequent requests from an authenticated client machine are directly forwarded to the server without re-performing the authentication procedure for that client. In an embodiment, an aging timer may be applied to re-authenticate clients. That is, an authenticated client may remain authenticated for a predefined period of time set by the aging timer.

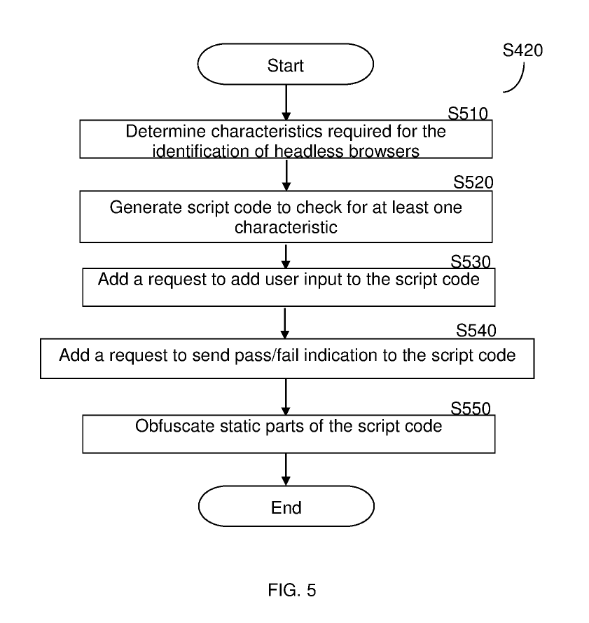

FIG. 5 shows an exemplary and non-limiting flowchart S420 describing the process for generating an AHBB challenge according to one embodiment. At S510, various characteristics required for the identification of headless browsers are determined. In one embodiment, such characteristics are determined by analyzing normal behavior of standard web browsers. For example, such characteristics may include whether the browser opened with a window size greater than zero, whether the browser displays an address, and whether the browser is installed with one or more plug-ins (e.g., toolbars, and the like). Other normal behavior or characteristics of standard web browsers should be apparent to one of ordinary skill in the art.

In addition, characteristics are determined by analyzing different types of headless browsers via identification of special objects utilized by such browsers. Such special objects are typically extensions for JavaScript engines allowing a headless browser to mimic execution of standard JavaScript engines. As an example, “window._phantom” is an example for such objects. Headless browsers that can be analyzed include, but are not limited to, PhantomJS, HtmlUnit, SlimerJS, CasperJS, ZombieJS, NightwatchJS, Chimera, Dalek.js, Ghost, Awesomium, and the like.

At S520, a script code is generated to check for the existence of at least one of the characteristics determined at S510. An indication as to whether the challenge passed or failed is determined respective of the checked existence. For example, if a special object is found, a “failed” indication is generated and a message respective thereof is returned by the script code. As another example, if an address bar is not identified by the script code (such characteristic does not exist), a “failed” indication is generated and a message respective thereof is returned by the script code. It should be noted that a single script code may define multiple checks of multiple characteristics such that any logic can be applied between such checks. For example, a generated script code may generate a failed indication upon identifying zero-window size and special checks. The number of characteristics may be determined based on allowable false alert rate, a type of the protected server, and so on. In an embodiment, the script code is a form of JavaScript.

Optionally, at S530, a request to provide a user input (by a user of the client machine) is added to the script code. The user input may be an interaction of the user (human) with an input/output device connected to the client machine, for example, a request for a mouse click, a mouse movement, and on the like.

At S540, a request to send the failed/passed indication is added to the code. At S550, static parts of the script code are obfuscated. The static parts are code lines often required for the proper interpretation of the code by a JavaScript engine. Such code lines can be obfuscated by any obfuscation techniques known in the related art. Once the generation of the script code challenge is completed, the script is sent to the client machine for execution thereto.

Following is an exemplary and non-limiting JavaScript AHBB challenge generated according to the disclosed embodiments.

<html>

<body>

<div>

<script>

if (window._phantom != null)

document.location = “failed.aspx”;

else

document.location = “Passed.aspx”;

</script>

</div>

</body>

<html>

In the exemplary script, the code line “if (window._phantom 1=null)” checks the existence of a special object “_phantom”. This is a special object of a PhantomJS headless browser. The challenge fails if such an object is found (document.location=“failed.aspx”); otherwise, the challenge passes.

Following is another non-limiting example for a JavaScript AHBB challenge generated according to the disclosed embodiments.

<html>

<body>

<div>

<script>

if (window.outerWidth == 0 && window.outerHeight
== 0){

//headless browser
document.location = “failed.aspx”;

}
else

document.location = “Passed.aspx”;

</script>

</div>

</body>

<html>

In the exemplary script, the code line “if (window.outerWidth==0 && window.outerHeight==0)” checks GUI window size. If the height and width of the GUI window is different the equals zero challenge fails (document.location=“failed.aspx”); otherwise, the challenge passes.

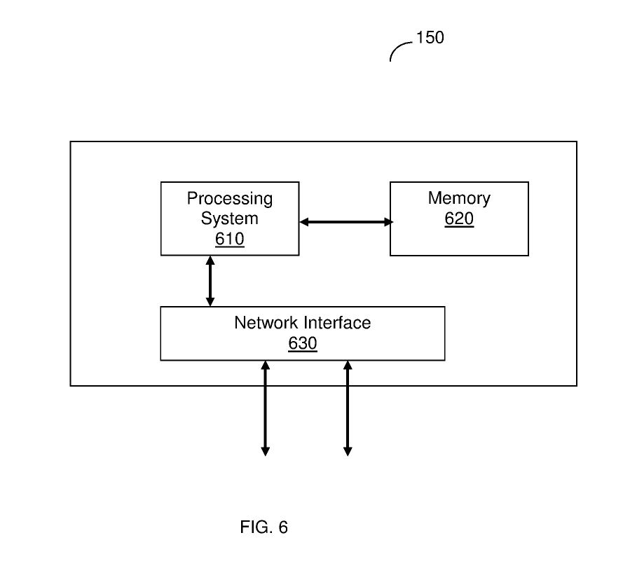

FIG. 6 shows an exemplary and non-limiting block diagram of the security system 150 constructed according to one embodiment. The system 150 is configured to verify client machines accessing a protected server and to detect malicious bots. The security system 150 includes a processing system 610 coupled to a memory 620, and a network interface 630.

The network interface 630 is configured to allow the communication with client machines and a protected server through a network (e.g., a network 130). The processing system 610 may comprise, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system 610 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit, cause the processing unit to perform the various functions.

The memory 620 may comprise volatile and/or non-volatile memory components, including but not limited to static random access memory (SRAM), dynamic random access memory (SRAM), Flash memory, magnetic memory and other tangible media on which data and/or instructions may be stored. The memory 620 may contain instructions that, when executed by the processing system 610, performs, for example and without limitations, the processes for detecting headless browsers and generating challenges as described in more detail in above. The memory 620 may also include one or more of a list of authenticated clients and their aging timers, a list of identified browsers' characteristics, a list of risk parameters, a list of load parameters and so on.

The various embodiments disclosed herein can be implemented as any combination of hardware, firmware, and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for detecting an access to a protected resource by headless browser bots, comprising:
receiving a request from a client machine;
generating an anti-headless browser bot (AHBB) challenge, wherein the AHBB challenge includes at least one headless browser identifying characteristic;
receiving a response to the AHBB challenge;
comparing the received response to at least one challenge requirement to determine a pass result or a fail result; and
upon determining a pass result, granting the client machine access to the protected resource.

2. The method of claim 1, further comprising:
determining whether the AHBB challenge should be generated, wherein the determination is based on at least one of: at least one risk parameter, and at least one load parameter.

3. The method of claim 2, wherein each of the at least one risk parameter is any of: a list of known malicious clients, a list of trusted clients and associated internet protocol (IP) addresses, a reputation score per IP address, a reputation score per geographic region, an application layer parameter, a client unique identification (ID) token, a client affiliation, a parameter from an authentication service, a geo analysis, a type of the protected resource, and an indication of an ongoing attack.

4. The method of claim 2, wherein the at least one load parameter relates to the protected resource and includes at least one of: a current load, an availability of computing resources, and an availability of networking resources.

5. The method of claim 1, wherein the fail result is determined at least when the response is not received within a predetermined time interval.

6. The method of claim 1, further comprising:
generating a new challenge based on a predefined escalation policy, when the fail result is determined.

7. The method of claim 1, wherein a web browser of the client machine is granted access to the protected resource for a predefined period of time, wherein the predefined period of time is set by an aging timer.

8. The method of claim 1, wherein generating the AHBB challenge further comprises:
identifying the at least one headless browser identifying characteristic;
generating a script code configured to check for the at least one headless browser identifying characteristic; and
configuring the script code to return a fail result upon identification of at least one headless browser characteristic.

9. The method of claim 1, wherein the at least one headless browser characteristic includes an object for processing at least Java script code.

10. The method of claim 1, wherein generating the AHBB challenge further comprises:
determining a test for detecting diversion from a normal behavior of a standard web browser;
generating a script code configured to execute the test on the client machine; and
configuring the script code to return the fail result upon identification of diversion from the normal behavior of a standard web browser.

11. The method of claim 1, wherein the test includes at least a zero-window size challenge.

12. The method of claim 8, wherein the script code is at least in JavaScript.

13. The method of claim 8, wherein the script code is at least one of: polymorphic, and obfuscated.

14. The method of claim 1, wherein the AHBB challenge further requires a human interaction.

15. A non-transitory computer readable medium having stored thereon instructions for causing one or more processing units to execute the computerized method according to claim 1.

16. A system for detecting an access to a protected resource by headless browser bots, comprising:
a processing system;
a memory connected to the processing system and configured to contain a plurality of instructions that when executed by the processing system configure the system to:
receive a request from a client machine;
generate an anti-headless browser bot (AHBB) challenge, wherein the AHBB challenge includes at least one headless browser identifying characteristic;
receive a response to the AHBB challenge;
compare the response to at least one challenge requirement to determine a pass result or a fail result; and
grant the client machine access to the protected resource, upon determining a pass result.

17. The system of claim 16, wherein the system is further configured to:
determine whether the AHBB challenge should be generated, wherein the determination is based on at least one of: at least one risk parameter, and at least one load parameter.

18. The system of claim 16, wherein each of the at least one risk parameter is any of: a list of known malicious clients, a list of trusted clients and associated internet protocol (IP) addresses, a reputation score per IP address, a reputation score per geographic region, an application layer parameter, a client unique identification (ID) token, a client affiliation, a parameter from an authentication service, a geo analysis, a type of the protected resource, and an indication of an ongoing attack.

19. The system of claim 16, wherein the at least one load parameter relates to the protected resource and includes any one of: a current load, an availability of computing resources, and an availability of networking resources.

20. The system of claim 16, wherein the fail result is determined at least when the response is not received in a predetermined time interval.

21. The system of claim 16, wherein the system is further configured to:
generate a new challenge based on a predefined escalation policy, upon determining the fail result.

22. The system of claim 16, wherein a web browser of the client machine is granted access to the protected resource for a predefined period of time, wherein the predefined period of time is set by an aging timer.

23. The system of claim 16, wherein the system is further configured to:
identify the at least one headless browser identifying characteristic;
generate a script code configured to check for the at least one headless browser identifying characteristic; and
configure the script code to return the fail result upon identification of at least one headless browser characteristic.

24. The system of claim 16, wherein the at least one headless browser characteristic includes an object for processing at least Java script code.

25. The system of claim 16, wherein the system is further configured to:
determine a test for detecting diversion from a normal behavior of a standard web browser; and
generate a script code configured to execute the test on the client machine; and
configure the script code to return the fail result upon identification of the diversion from the normal behavior of a standard web browser.

26. The system of claim 25, wherein the test includes at least a zero-window size challenge.

27. The method of claim 23, wherein the script code is at least one of: polymorphic, and obfuscated.
